(19) United States
(12) Patent Application Publication
(10) Pub. No.: US 2008/0195814 A1
(43) Pub. Date: Aug. 14, 2008

(54) Multi-functional storage device

(75) Inventor: Hsun-Lteh Chuang, Hsin Tien City (TW)

Correspondence Address: Troxell Law Office Pllc, Suite 1404, 5205 Leesburg Pike, Falls Church, VA, 22041, US

(73) Assignee: Heisei Electronics Co., Ltd.

(21) Appl. No.: 11/703,834

(22) Filed: Feb. 8, 2007

(51) Int. Cl. G06F 13/00; G09G 3/36

(52) U.S. Cl. 711/115; 345/87

(57) ABSTRACT

A multi-functional storage device is composed of a container, a side of which is provided with a transmission wire which is used to connect with a computer, and an interior of which is installed with a hard disk and a circuit board. On the other hand, the other side of the storage device is provided with a display device, such that a current condition of the hard disk can be available more quickly through the display device, thereby facilitating a user to manage the condition of the hard disk.

### BACKGROUND OF THE INVENTION

(a) Field of the Invention

The present invention relates to a multi-functional storage device, and more particularly to a storage device wherein a side of which is provided with a display device, such that a condition of a hard disk can be detected by a circuit board and then displayed on the display device.

(b) Description of the Prior Art

A conventional storage device can be only used to connect with a computer, and is not provided with any displace device which can detect and display a condition of a hard disk. Therefore, if the hard disk is malfunctioning, the current condition of the hard disk cannot be detected immediately, which will cause inconvenience in managing the hard disk for a user.

### SUMMARY OF THE INVENTION

The primary object of present invention is to provide a multi-functional storage device, a side of which is provided with a display device, such that a condition of a hard disk can be detected by a circuit board and then displayed on the display device, so as to facilitate a user to control and manage the condition of the hard disk.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows an exploded view of the present invention.

FIG. 3 shows a schematic view of an embodiment of the present invention.

FIG. 4 shows a schematic view of a second embodiment of the present invention.

FIG. 5 shows a schematic view of a third embodiment of the present invention.

### DETAILED DESCRIPTION OF THE PREFERRED EMBODIMENTS

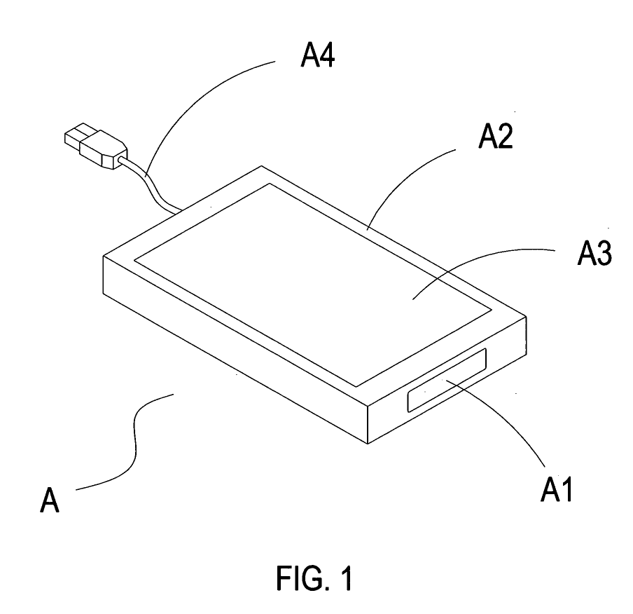

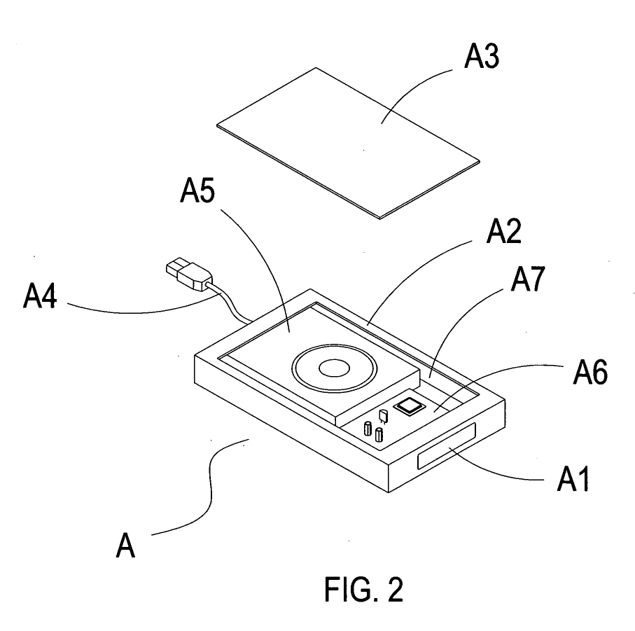

The present invention is to provide a multi-functional storage device A, as shown in FIG. 1 and FIG. 2, which includes a container A2, an upper lid A3, and a transmission wire A4. An interior of the container A2 of the storage device A is provided with a sink A7 which is used to emplace a hard disk A5, a side of the sink A7 is provided with a circuit board A6 which is connected with the hard disk A5, and the circuit board A6 is mutually corresponding to a display device A1. In addition, a side of the container A2 is extended with the transmission wire A4 which is connected with a computer, and the upper lid A3 of the storage device A is corresponding to the container A2.

The display device A1 of the storage device A can be an LCD (Liquid Crystal Display), an LED (Light-Emitting Diode), or any device which can display a condition of function. On the other hand, the storage device A can be further a personal disk, a disk, or other related storage devices.

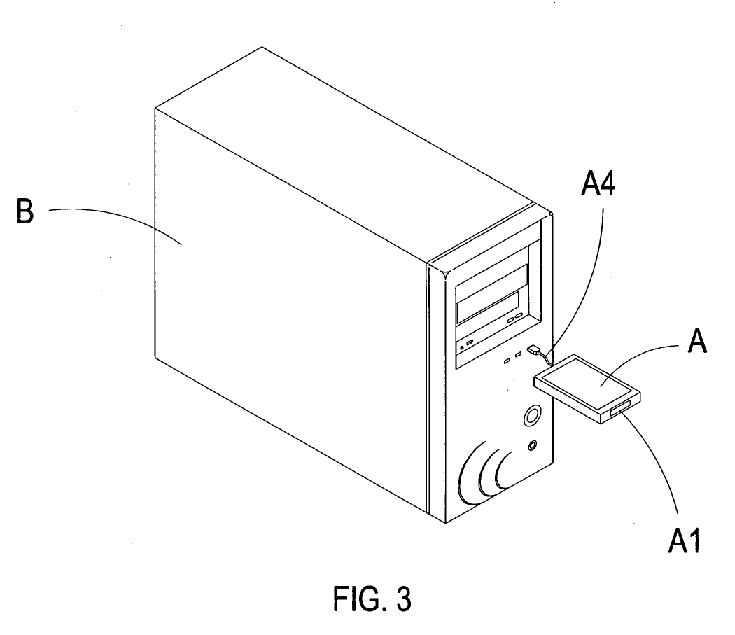

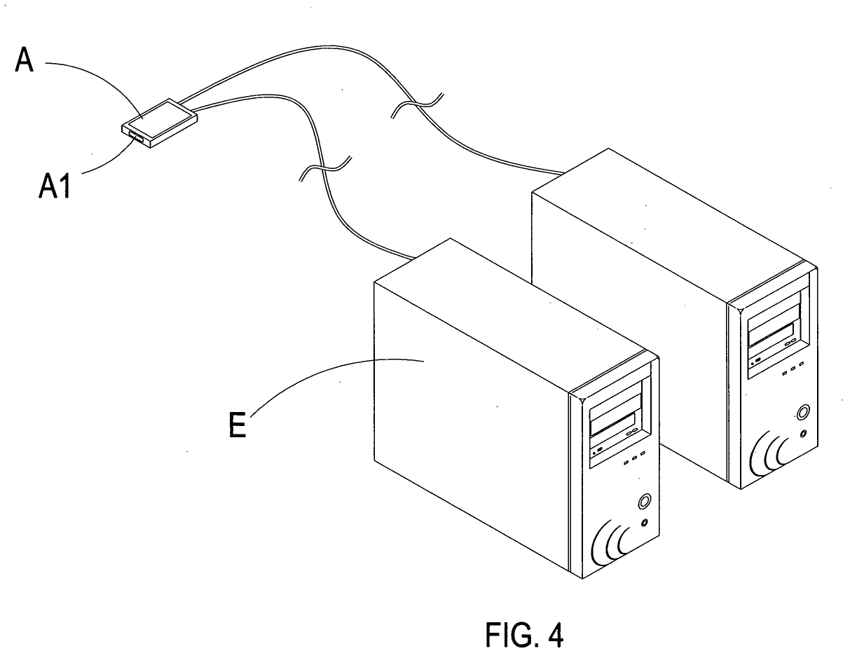

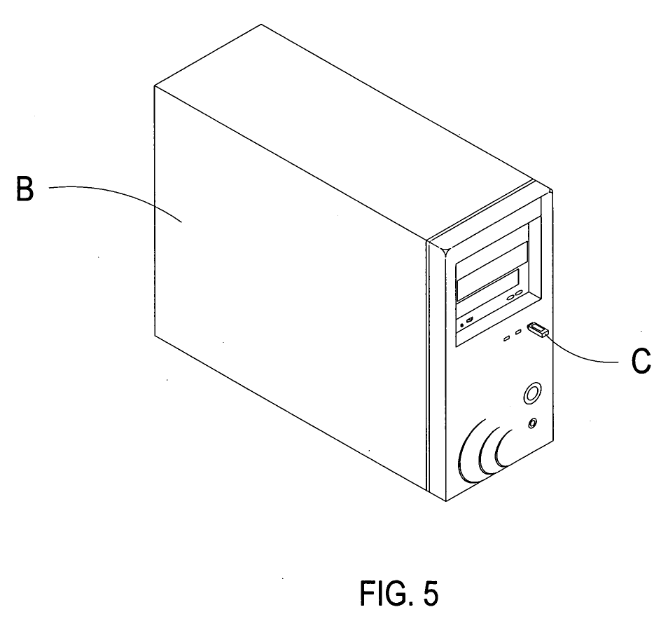

Referring to FIGS. 2 to 5, upon using a multi-functional storage device of the present invention, a hard disk A5 is first installed in a sink A7 of a container A2 to be connected with a circuit board A6 in the sink A7, and then an upper lid A3 of the storage device A is latched with the container A2 of the storage device A. After the hard disk A5 is installed in the storage device A, a transmission wire A4 of the storage device A is connected to a computer B, and the storage device A is electrically conducted. After the storage device A is electrically conducted, a current condition of the hard disk A5 will be detected by the circuit board A6 of the storage device A, and the circuit board A6 of the storage device A will transmit the detected condition of the hard disk A5 to a display device A1 of the storage device A for displaying. Therefore, the current condition of the hard disk A5 can be directly available through the display device A1 of the storage device A, and when something happens to the hard disk A5, a user can immediately find out and be aware of the condition of the hard disk A5, thereby facilitating the user to control, manage and be aware of the current condition of the hard disk A5.

The storage device A can be further used in a remote accessing and surveillance application, wherein a plurality of computers E is provided remotely and the hard disk A5 is located in the storage device A. When storage capacity of the hard disk A5 of the storage device A is full, the user can directly check the current condition of the hard disk A5 at the display device A1 of the storage device A, thereby facilitating the user to monitor the condition of the hard disk A5. Moreover, the storage device A can be further configured as a storage device, such as a personal disk C.

In order to further manifest the advancement and the practicability of the present invention, the advantages thereof are listed below:

1. It can be installed on a computer conveniently.

2. A condition of a hard disk can be displayed immediately.

3. It can facilitate a user to monitor the condition of the hard disk.

4. It is provided with industrial competitiveness.

5. It is provided with value of business utilization.

6. It is provided with novelty.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multi-functional storage device comprising a container and an upper lid, wherein the container of the storage device is extended with a transmission wire which is connected with a computer, an interior of the container of the storage device is provided with a circuit board, and the other side of the container is mutually corresponding to the upper lid; a side of the storage device being provided with a display device, such that a current condition of a hard disk is directly available through the display device, thereby facilitating a user to control, manage and to be aware of the current condition of the hard disk.

2. The multi-functional storage device according to claim 1, wherein the circuit board is used to connect with the hard disk for detecting the condition of the hard disk, which is then displayed on the display device.

3. The multi-functional storage device according to claim 1, wherein the display device is an LCD (Liquid Crystal Display), an LED (Light-Emitting Diode), or any device which displays a condition of function.

4. The multi-functional storage device according to claim 1, wherein the storage device is further configured as a personal disk, a disk, or other related storage devices.
